(19) United States
(12) Patent Application Publication
(10) Pub. No.: US 2010/0328101 A1
(43) Pub. Date: Dec. 30, 2010

(54) SYSTEM FOR INFLUENCING TRAFFIC IN A STREET NETWORK

(75) Inventors: Oliver Gräbner, Munchen (DE); Tobias Layer, Gauting (DE); Ingolf Rauh, Reichenau (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munchen (DE)

(21) Appl. No.: 12/826,849

(22) Filed: Jun. 30, 2010

(30) Foreign Application Priority Data
Jun. 30, 2009 (DE) 10 2009 031 322.2

(51) Int. Cl. G08G 1/09

(52) U.S. Cl. 340/905

(57) ABSTRACT

A traffic control system allows traffic in a road network, particularly in a heavily populated area, to be influenced. In the road network, a road user traveling by a private transport vehicle can choose, at a stop for a public means of transport which has an associated parking facility for the private transport vehicle, whether to continue to travel by the private transport vehicle or by the public means of transport. Influencing elements output traffic information to the road user traveling by the private transport vehicle which is suitable for influencing the choice of means of transport by the road user. Ascertainment devices are provided for the purpose of ascertaining the traffic information which is to be output. A control center actuates the influencing elements dynamically on the basis of the ascertained traffic information. In line with the invention, the ascertainment devices are designed to ascertain costs which are incurred for the road user when choosing one of the means of transport. The traffic information which is to be output by the influencing elements comprises the ascertained costs.

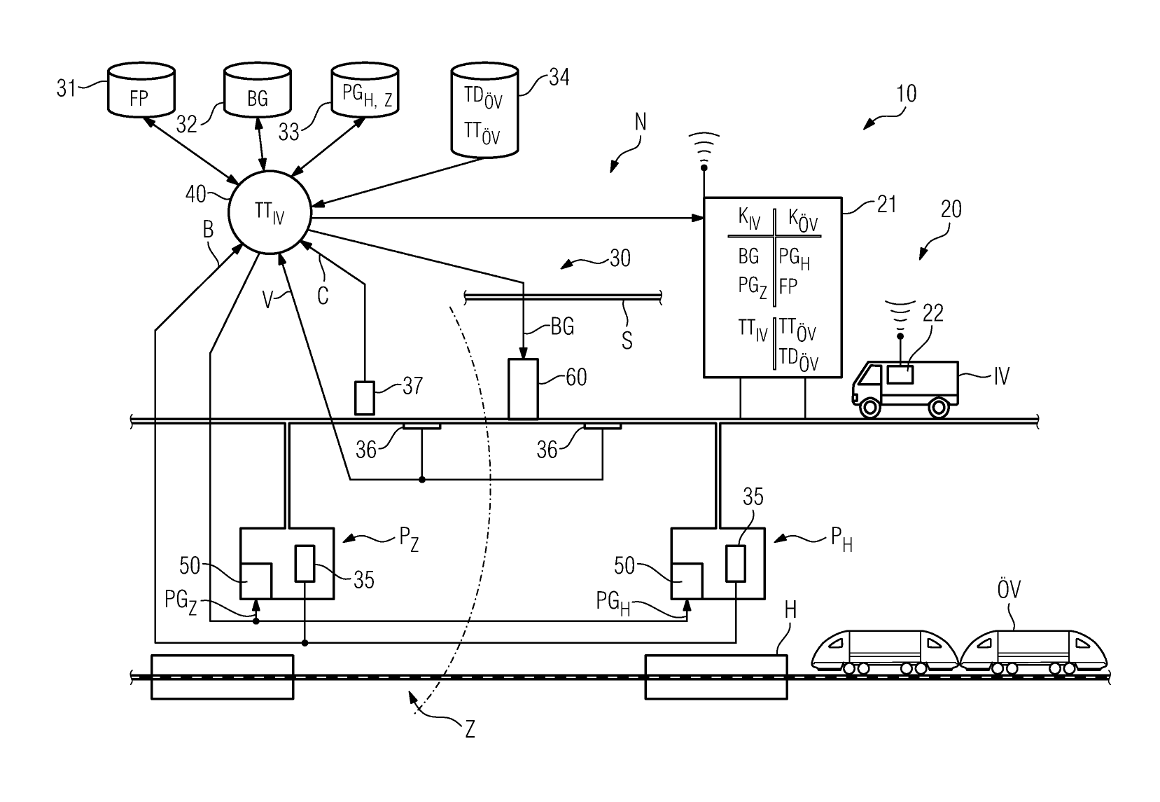

### CROSS-REFERENCE TO RELATED APPLICATION

This application claims the priority, under 35 U.S.C. §119, of German application DE 10 2009 031 322.2, filed Jun. 30, 2009; the prior application is herewith incorporated by reference in its entirety.

### BACKGROUND OF THE INVENTION

### Field of the Invention

The invention relates to a system for influencing traffic in a road network, particularly in a heavily populated area, in which a road user traveling by a private means of transport can choose, at a stop for a public means of transport which has an associated parking facility for the private means of transport, whether to continue to travel by the private means of transport or by the public means of transport. The system includes influencing elements for outputting traffic information to the road user traveling by the private means of transport, wherein the traffic information is suitable for influencing the choice of means of transport by the road user, ascertainment devices for ascertaining the traffic information which is to be output, and a control center for dynamically actuating the influencing elements on the basis of the ascertained traffic information.

Throughout the world, cities and metropolitan areas are confronted by the same challenging task: managing the growing traffic on usually nonextendable road networks, satisfying the legitimate need for mobility—and the equally valid demand for clean air. Urban traffic control centers are today able to use accessible interfaces to forward reliable traffic information to a wide variety of external service providers. On the basis of these data, navigation systems can guide the user to the destination reliably and on the fastest route and in so doing automatically take account of queues and diversions. Queue warnings, traffic information and journey time calculations disseminated via the Internet and radio also assist in finding the route which is most favorable in terms of traffic. Furthermore, the traffic control centers provide direct influence on dynamic display panels showing diversion recommendations, ice, fog or traffic jam warnings and speed restrictions. Wind, weather and industrial emissions cannot be influenced even by measures which direct traffic. However, the proportion of air pollution which can be attributed to heavy goods vehicles and private motor vehicles as a result of their exhaust, abrasion and swirl-up can be significantly reduced by a traffic management system. If the total pollution becomes too great and approaches regulatory limit values, it is therefore necessary to take appropriate measures quickly and efficiently, for example by relocating traffic streams or closing particular districts to particular types of vehicles.

The German product specification “SITRAFFIC Concert, SITRAFFIC Scala and SITRAFFIC Guide: Drei Aufgaben—eine gemeinsame Plattform” [SITRAFFIC Concert, SITRAFFIC Scala and SITRAFFIC Guide: three tasks—a common platform], published in 2008 by Siemens AG under order No. E10003-A800-A64-V1, discloses a traffic control center for influencing traffic in a road network which, depending on modular compilation, performs functions pertaining to traffic management, traffic control and parking management. This is possible only if a large volume of data is collected from a wide variety of sources, processed to form information, forwarded in a targeted manner and converted into traffic re-routing measures but in the context of intelligent strategies. The efficient reduction in air pollution has knowledge of the current pollution situation—that is to say the emissions—as an absolute prerequisite. The integration of appropriate environmental models into the known traffic control center allows measures to be introduced precisely at that time and that location at which they are required. Strategic traffic management thus provides the opportunity to take action using the respective required strategies in line with the current situation, and at the same time to give the go-ahead in the case of noncritical weather situations, for example.

The prior approaches for combating the increasing traffic and pollutant burdens in heavily populated areas are based on situation-dependent rearrangement—if necessary stoppage—of private transport in city-center road networks. A potential way of easing traffic and hence the environment in heavily populated areas which has been exploited too little to date involves the use of public means of transport, particularly the combined use of private and public means of transport. To this end, parking facilities for motor vehicles are known which are associated with stops for public means of transport. Such “park-and-ride parking lots” at subway or town and suburban railway stops provide road users who are traveling by a private means of transport in the direction of the city center of the heavily populated area with the opportunity to continue their journey using the public means of transport.

To this end, the known traffic control center provides the opportunity to actuate parking signs. The display panels can be used to display occupancy states for connected parking facilities, both parking facilities associated with the stop and parking facilities in the city center area. In addition, there is the opportunity to display currently required journey times which are needed for particular routes following the location in the road network. Finally, parking facilities which are associated with a stop for public means of transport have displays about the next departure times for the public means of transport. However, the known measures are only able to prompt an inadequate proportion of road users driving private means of transport to continue the journey by a public means of transport so as to ease the town-center traffic and environment situations.

### SUMMARY OF THE INVENTION

It is accordingly an object of the invention to provide a system for influencing traffic in a road network which overcomes the above-mentioned disadvantages of the heretofore-known devices and methods of this general type and which provides for a traffic influencing system of the type cited at the outset which is able to improve the situation-dependent easing of the traffic and environment situations in a heavily populated area.

With the foregoing and other objects in view there is provided, in accordance with the invention, a system for influencing traffic in a road network, in particular in easily congested areas, wherein a road user traveling by private transport vehicle is provided a choice, at a stop for a public means of transport having an associated parking facility for the private transport vehicle, whether to continue travel by way of the private transport vehicle or by way of public transportation, the system comprising:

ascertainment devices for ascertaining traffic information to be output, said ascertainment devices being configured to ascertain costs incurred for the road user when choosing further travel by private transport vehicle or by public transportation;

influencing elements for outputting the traffic information to the road user traveling by the private transport vehicle, the traffic information being suitable for influencing the road user's choice of means of transport for further travel and including costs ascertained by said ascertainment devices; and

a control center for dynamically actuating said influencing elements based on the traffic information ascertained by said ascertainment devices.

In other words, the objects of the invention are achieved by means of a traffic influencing system of the type cited at the outset in which the ascertainment devices are designed to ascertain costs which are incurred for the road user when choosing one of the means of transport, wherein the traffic information which is to be output by the influencing elements comprises the ascertained costs. The traffic influencing system according to the invention is based on the output of traffic information to the road user traveling by a private means of transport at or before a stop for a public means of transport, said traffic information providing a great incentive to change from the private means of transport to the public means of transport. This incentive is intended to be given by means of information about costs which will be incurred for the road user if he continues his journey by one or the other means of transport.

In one advantageous embodiment of the traffic influencing system according to the invention, the influencing elements are designed to simultaneously output the costs for continuing to travel by the private means of transport in comparison with the costs for continuing to travel by the public means of transport. A comparative illustration of costs which are incurred using the respective means of transport allows the road user to quickly sense the presented traffic information and make his decision about the choice of means of transport for continuing his journey without large strides in thought. This is of particular advantage if the road user is driving when he picks up the output traffic information, because he is driving a vehicle.

In one preferred refinement of the traffic influencing system according to the invention, the influencing elements comprise display devices arranged at the roadside in advance of stops. Such display devices in the form of information panels with freely programmable text rows are partially in place and road users are accustomed to this type of information presentation. Typical of such display devices are character representations through LED matrices, which are particularly durable and power-saving.

In one preferred embodiment of the traffic influencing system according to the invention, the influencing elements comprise terminals arranged in private means of transport for wireless broadcast radio reception and/or data network access. A radio can be used to receive traffic information which is output by means of broadcast radio, and said information can be perceived audibly by the road user. In addition or as an alternative, the traffic information which is to be output can be received wirelessly via navigation appliances or mobile radios which are carried in the vehicle and can be reproduced audibly and/or visually on a display. These opportunities for obtaining traffic information are independent of location, in comparison with roadside display devices. This provides a road user with an advantage arising from longer decision times for the selection of the means of transport.

In one preferred embodiment of the traffic influencing system according to the invention, the ascertainment devices have a memory device or are connected thereto, said memory device storing current fares for the public means of transport in retrievable form. Said memory device may either form part of the control center and be kept up to date with the respective current fares by the operator of the public means of transport, or the control center provides a data link to a memory device of the operator of the public means of transport which independently maintains its memory device with the current fares. In each case, the system has the current fares for the public means of transport, which can be output as a cost item by the influencing elements.

In a further advantageous embodiment of the traffic influencing system according to the invention, the ascertainment devices have a memory device or are connected thereto, said memory device storing current use charges for tollable routes and/or zones in the road network in retrievable form. If a road user continuing his journey by his private means of transport needs to use a tollable route or needs to enter a tollable zone, for example a defined city center area, in order to reach his journey destination, the use charge which is due is an important piece of traffic information for the road user. So that said piece of information can be output by the influencing elements, the system according to the invention needs to have the respective current use charges. To this end, the control center of the traffic influencing system either has a memory device itself in which the current road use charges are maintained by the toll system operator, or it is connected to such a memory device which is arranged in a toll system control center. In both cases, the traffic influencing system according to the invention has the current use charges for tollable routes and/or zones in the road network under consideration.

In another preferred refinement of the traffic influencing system according to the invention, the ascertainment devices have a memory device or are connected thereto, said memory device storing current parking charges for the parking facility associated with the stop and/or current parking charges for a parking facility associated with a journey destination for the road user in retrievable form. Hence, the traffic information firstly contains the parking charges which are due if the road user parks his private means of transport in a parking facility associated with the stop in order to continue his journey by the public means of transport. Secondly, it contains the parking charges which the road user can expect if he continues his journey by his private means of transport and if he parks said means of transport in a parking facility associated with his journey destination. Typically, the parking charges for the park-and-ride parking lot at the edge of the town and those for a multistory parking lot close to the center are thus brought together for comparison. So that the current parking charges are available to the traffic influencing system, either the control center itself has a memory device which is used to store the current parking charges obtained from the respective parking space operator, or it is connected to a memory device of the parking lot operator which maintains the current charges therein itself.

In a further advantageous refinement of the traffic influencing system according to the invention, the ascertainment devices have a memory device or are connected thereto, said memory device storing current timetables with departure times and/or journey times for the public means of transport in retrievable form. Besides the cost information, journey time information may be a significant decision aid for the choice of means of transport. The timetable information for the public means of transport typically comprises the next departure time from the current time of day and the required journey time from the present stop to a stop close to the center, so that the road user can estimate the time required when changing from the private means of transport to the public means of transport. This information is typically retrieved from a database of the operator of the public means of transport which keeps said database up to date. If appropriate, said database may contain delay announcements or nonscheduled journey time extensions.

In a further preferred refinement of the traffic influencing system according to the invention, the ascertainment devices also have vehicle detectors for sensing a current occupancy situation for at least one of the parking facilities. Vehicle detectors in the form of ultrasound or video detectors, for example, can be used to monitor the individual spaces in the relevant parking facilities, so that the parking facilities are able to transfer the respective current occupancy state to the control center, said occupancy state then being output as traffic information by means of the influencing elements. The occupancy situations of the relevant parking facilities may likewise be a significant decision criterion for the choice of means of transport.

In another advantageous embodiment of the traffic influencing system according to the invention, the ascertainment devices also have traffic detectors for sensing a current traffic situation, particularly currently required journey times, in the road network. The traffic detectors in the form of inductive loops or video detectors, for example, are arranged distributed in the road network and record traffic levels and average speeds in the road network using count and occupancy values. Traffic models or video techniques are used to ascertain current journey times for route sections of the road network, in particular, from said traffic data. The output of the journey times required for a private means of transport by the influencing elements is likewise, per se and particularly in comparison with the corresponding journey time for a public means of transport, a significant decision criterion for the road user when choosing the means of transport.

In another preferred embodiment of the traffic influencing system according to the invention, the ascertainment devices also have environment sensors for sensing a current pollutant situation in the road network. By way of example, the environment sensors are designed to sense particulate and NO_{X} concentrations at suitable measurement points in the road network in order to ascertain the current pollutant situation. On the basis of the currently prevailing pollutant situation and/or the currently prevailing traffic situation in the road network, the influencing elements can be used to implement appropriate control measures.

Thus, in one particularly preferred refinement of the traffic influencing system according to the invention, the control center is connected to a parking meter which is associated with at least one of the parking facilities and which is designed to dynamically stipulate and pay parking charges for the parking facilities, the control center is connected to a toll station which is associated with the tollable route and/or zone and which is designed to dynamically stipulate and pay use charges, and the control center is designed to stipulate the level of the parking charges and/or the use charges on the basis of the sensed traffic situation and/or pollutant situation and to transmit said charges to the parking meter and/or to the toll stations and also to the memory devices. This means that targeted influence on the choice of means of transport in the road network of the heavily populated area is possible on the basis of the currently prevailing traffic and environment situation. If traffic congestion and/or transgression of admissible pollutant concentration limits is/are found in the city center area, for example, it is possible for toll charges and parking charges in the city center area to be raised centrally, while the parking charges at stops for public means of transport at the edge of the town can be reduced. These charge adjustments can be transmitted centrally to the connected toll stations and parking meters and also to the influencing elements.

Other features which are considered as characteristic for the invention are set forth in the appended claims.

Although the invention is illustrated and described herein as embodied in a system for influencing traffic in a road network, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE INVENTION

The single FIGURE of the drawing is a schematic illustration of the traffic influencing system according to the invention.

### DETAILED DESCRIPTION OF THE INVENTION

Referring now to the FIGURE of the drawing in detail, a road network N in a heavily populated area has untolled routes but also tollable routes S for private means of transport IV, referred to as private transport vehicles, that is to say motorcycles or motor vehicles. In the exemplary embodiment shown, traveling through a zone Z of the road network N, for example the city center, is chargeable. In the exemplary embodiment shown, the road user drives his private means of transport IV on an access road on which a stop H for a public means of transport ÖV, referred to as public transportation, for example a metro railway, a city and suburban railway, or regional railway, is located at the edge of the town. The stop H has an associated parking facility P_{H} at which the road user can park his private transport vehicle IV in order to be able to continue his journey into the zone Z by the public transportation ÖV. Alternatively, he can continue his journey into the zone Z by his private transport vehicle IV.

In order to provide an incentive for the road user to change to the public means of transport ÖV, for reasons which are described further below, a system 10 according to the invention for influencing traffic in the road network N has influencing elements 20 which can be used to output traffic information to the road users traveling by the private means of transport IV. In this case, the traffic information needs to be suitable for influencing the choice of means of transport by the road user. The influencing elements 20 are available in advance of the parking facility P_{H} as display devices 21 arranged at the roadside and also terminals 22 carried in the private means of transport IV. The terminals 22 are designed for broadcast radio reception and/or data network access, for example to the Internet.

In line with the invention, the traffic information which is to be output by the influencing elements 20 comprises costs K_{IV} which are incurred for continuing to travel by the private means of transport IV and also costs K_{ÖV} which are incurred for continuing to travel by the public means of transport ÖV. A cost comparison forms a quickly perceivable decision aid for the road user.

In the exemplary embodiment shown, the costs K_{IV} incurred for continuing to travel by the private means of transport IV are, firstly, use charges BG either for tollable routes S or for traveling through a tollable zone Z and also parking charges PG_{Z} for parking the private means of transport IV in a parking facility P_{Z} associated with the journey destination. By contrast, costs K_{ÖV} which are incurred for changing to the public means of transport ÖV are firstly the fare FP for using the public means of transport ÖV and also parking charges PG_{H} for parking the private means of transport IV in a parking facility P_{H} associated with the stop H.

In addition, the respective journey times for using the private means of transport IV and for using the public means of transport ÖV can be compared. The departure times TD_{ÖV} and also the journey times TT_{ÖV} for the public means of transport ÖV are obtained by the control center 40 from a memory device 34 for timetables for the public means of transport ÖV. The journey time TT_{IV} for the private means of transport IV is provided by the control center 40 in the traffic influencing system 10 using ordinary model calculations on the basis of the currently ascertained traffic situation V in the road network N. Hence, the road user in the private means of transport IV has a comparison of the probably required journey time to his journey destination as a further decision criterion. The charge information is provided for the control center 40 in a memory device 31 for fares FP for the public means of transport ÖV, in a memory device 32 for use charges BG and a memory device 33 for parking charges PG. The memory devices 31 to 34 are either arranged in the control center 40 or, if arranged in distributed fashion with an operator, the control center 40 is connected to these.

The road network N contains traffic detectors 36 in a distributed arrangement which ascertain a traffic situation V in the road network. By way of example, the traffic detectors 36 are in the form of inductive loops or in the form of video detectors and transmit their data, namely count, occupancy and speed values, to the control center 40 at regular intervals. Similarly, the road network N of the heavily populated area contains environment sensors 37 in a distributed arrangement which sense the current pollutant situation C and likewise transmit it to the control center 40 on a current basis. By way of example, the environment sensors 37 comprise the particulate pollution and also the current NO_{X} content of the air. Finally, the parking facilities P_{Z} and P_{H} have vehicle detectors 35 arranged on them which sense an occupancy situation B for the parking facilities P_{Z} and P_{H} and regularly transmit it to the control center 40. Hence, the control center 40 of the traffic influencing system 10 has current situation reports available about the heavily populated area which are critical for the taking of control measures for the traffic.

In line with the invention, this is because use charges BG and parking charges PG can be stipulated afresh depending on the traffic and pollutant situation V and C. If there is a high level of pollution or traffic congestion in the city center area Z, for example, the influencing elements 20 can be used to provide cost incentives which influence road users to change to public means of transport ÖV. To this end, by way of example, the use charges BG and the parking charges PG_{Z} for parking facilities P_{Z} which are associated with the journey destination are increased, while the parking charges PG_{H} for a parking facility P_{H} which is associated with the stop H are reduced. When the pollutant or traffic situation C or V in the zone Z is eased, the charge structure can once more be adjusted. This requires the control center 40 to transmit the currently stipulated charge levels by means of data transmission to parking meters 50 of the parking facilities P_{Z} and P_{H} at which parking charges PG_{Z} and PG_{H} are paid and to a toll station 60 at which the road use charges BG are paid.

1. A system for influencing traffic in a road network, wherein a road user traveling by private transport vehicle is provided a choice, at a stop for a public means of transport having an associated parking facility for the private transport vehicle, whether to continue travel by way of the private transport vehicle or by way of public transportation, the system comprising:
ascertainment devices for ascertaining traffic information to be output, said ascertainment devices being configured to ascertain costs incurred for the road user when choosing further travel by private transport vehicle or by public transportation;
influencing elements for outputting the traffic information to the road user traveling by the private transport vehicle, the traffic information being suitable for influencing the road user's choice of means of transport for further travel and including costs ascertained by said ascertainment devices; and
a control center for dynamically actuating said influencing elements based on the traffic information ascertained by said ascertainment devices.

2. The system according to claim 1, wherein said influencing elements are configured to simultaneously output the costs for continuing to travel by way of the private transport vehicle in comparison with the costs for continuing to travel by public transportation.

3. The system according to claim 1, wherein said influencing elements comprise display devices arranged at the roadside in advance of stops.

4. The system according to claim 1, wherein said influencing elements comprise terminals arranged in the private transport vehicle for wireless broadcast radio reception and/or data network access.

5. The system according to claim 1, wherein said ascertainment devices include a memory device or are connected to a memory device, said memory device storing current fares for the public means of transport in retrievable form.

6. The system according to claim 1, wherein said ascertainment devices include a memory device or are connected to a memory device, said memory device storing current use charges for tollable routes and/or zones in the road network in retrievable form.

7. The system according to claim 1, wherein said ascertainment devices include a memory device or are connected to a memory device, said memory device storing current parking charges for the parking facility associated with the stop and/or current parking charges for a parking facility associated with a journey destination for the road user in retrievable form.

8. The system according to claim 1, wherein said ascertainment devices include a memory device or are connected to a memory device, said memory device storing current timetables with departure times and/or journey times for the public means of transport in retrievable form.

9. The system according to claim 1, wherein said ascertainment devices include one or more memory devices or are connected to one or more memory device, said memory devices storing current fares for the public means of transport, current use charges for tollable routes and/or zones in the road network, current parking charges for the parking facility associated with the stop and/or current parking charges for a parking facility associated with a journey destination for the road user, and current timetables with departure times and/or journey times for the public means of transport, each in retrievable form.

10. The system according to claim 1, wherein said ascertainment devices include vehicle detectors for sensing a current occupancy situation for at least one of the parking facilities.

11. The system according to claim 1, wherein said ascertainment devices include traffic detectors for sensing a current traffic situation in the road network.

12. The system according to claim 11, wherein said traffic detectors are configured to determine currently required journey times.

13. The system according to claim 1, wherein said ascertainment devices include environment sensors for sensing a current pollutant situation in the road network.

14. The system according to claim 1, wherein:
said control center is connected to a parking meter which is associated with at least one of the parking facilities and which is configured to dynamically stipulate and pay parking charges for the parking facility;
said control center is connected to a toll station which is associated with the tollable route and/or zone and which is configured to dynamically stipulate and pay use charges; and
said control center is configured to stipulate a level of the parking charges and/or the use charges on the basis of the sensed traffic situation and/or pollutant situation and to transmit said charges to the parking meter and/or to the toll stations and also to the memory devices.
